(19) United States
(12) Patent Application Publication
(10) Pub. No.: US 2008/0159694 A1
(43) Pub. Date: Jul. 3, 2008

(54) Lens Configurations for Optical Touch Systems

(75) Inventor: Jonathan Payne, Acton (AU)

Correspondence Address: MILLER, MATTHIAS & HULL, ONE NORTH FRANKLIN STREET, SUITE 2350, CHICAGO, IL, 60606, US

(73) Assignee: RPO Pty Limited, Acton (AU)

(21) Appl. No.: 11/965,230

(22) Filed: Dec. 27, 2007

Related U.S. Application Data
(60) Provisional application No. 60/969,564, filed on Aug. 31, 2007.
(60) Provisional application No. 60/968,794, filed on Aug. 29, 2007.
(60) Provisional application No. 60/882,113, filed on Dec. 27, 2006.

(51) Int. Cl. G02B 6/32; C03B 37/00

(52) U.S. Cl. 385/33; 65/387

(57) ABSTRACT

An optical system (21) is disclosed, that includes a plurality of waveguides (10, 14) on a substrate (22) and a unitary collimating lens element (23) adjacent and optically coupled to the waveguides (10, 14) and on the same substrate (22). Methods for producing optical systems (21) and a plurality of optical signals are also disclosed. A collimating lens element (23) for the optical system (21) is also disclosed

### TECHNICAL FIELD

Lens configurations for optical touch systems and other applications are disclosed

### BACKGROUND

Touch input devices or sensors for computers and other consumer electronics devices such as mobile phones, personal digital assistants (PDAs) and hand-held games are highly desirable due to their extreme ease of use. In the past, a variety of approaches have been used to provide touch input devices. The most common approach uses a flexible resistive overlay, although the overlay is easily damaged, can cause glare problems, and tends to dim an underlying display, requiring excess power usage to compensate for such dimming. Resistive devices can also be sensitive to humidity, and the cost of the resistive overlay scales quadratically with perimeter. Another approach is capacitive touch, which also requires an overlay. In this case the overlay is generally more durable, but the glare and dimming problems remain.

In yet another common approach, a matrix of infrared light beams is established in front of a display, with a touch detected by the interruption of one or more of the beams Such ‘optical’ touch input devices have long been known (U.S. Pat. No. 3,478,220; U.S. Pat. No. 3,673,327), with the beams generated by arrays of optical sources such as light emitting diodes (LEDs) and detected by corresponding arrays of detectors (such as phototransistors). They have the advantage of being overlay-free and can function in a variety of ambient light conditions (U.S. Pat. No. 4,988,983), but have a significant cost problem in that they require a large number of source and detector components, as well as supporting electronics. Since the spatial resolution of such systems depends on the number of sources and detectors, this component cost increases with display size and resolution.

An alternative optical touch input technology, based on integrated optical waveguides, is disclosed in U.S. Pat. No. 6,351,260, U.S. Pat. No. 6,181,842 and U.S. Pat. No. 5,914,709, and in US Patent Application Nos. 2002/0088930 and 2004/0201579. The basic principle of such a device is shown in FIG. 1. In this optical touch input device, integrated optical waveguides (‘transmit’ waveguides) 10 conduct light from a single optical source 11 to integrated in-plane lenses 16 that collimate the light in the plane of a display and/or input area 13 and launch an array of light beams 12 across that display and/or input area 13. The light is collected by a second set of integrated in-plane lenses 16 and integrated optical waveguides (‘receive’ waveguides) 14 at the other side of the screen and/or input area, and conducted to a position-sensitive (ie. multi-element) detector 15. A touch event (e.g by a finger or stylus) cuts one or more of the beams of light and is detected as a shadow, with position determined from the particular beam(s) blocked by the touching object. That is, the position of any physical blockage can be identified in each dimension, enabling user feedback to be entered into the device. Preferably, the device also includes external vertical collimating lenses (VCLs) 17 adjacent to the integrated in-plane lenses 16 on both sides of the input area 13, to collimate the light beams 12 in the direction perpendicular to the plane of the input area. Such prior art VCLs 17 are shown in cross section in FIG. 2.

The touch input devices are usually two dimensional and rectangular, with two arrays (X, Y) of transmit waveguides 10 along adjacent sides of the input area, and two corresponding arrays of receive waveguides 14 along the other two sides. As part of the transmit side, in one embodiment a single optical source 11 (such as an LED or a vertical cavity surface emitting laser (VCSEL)) launches light via some form of optical power splitter 18 into a plurality of waveguides that form both the X and Y transmit arrays. The X and Y transmit waveguides are usually fabricated on an L shaped substrate 19, and likewise for the X and Y receive waveguides, so that a single source and a single position-sensitive detector can be used to cover both X and Y dimensions. However in alternative embodiments, a separate source and/or detector may be used for each of the X and Y dimensions. For simplicity, FIG. 1 only shows four waveguides per side of the input area 13; in actual touch input devices there will generally be sufficient waveguides for substantial coverage of the input area

The design of prior art VCLs 17 poses a number of problems, especially in use. For example, they are relatively expensive to produce, and make the optical system relatively costly to produce since there are a number of components that must be assembled in a step-wise fashion. Furthermore, the “reference shelf” 20 upon which the waveguides are situated is less than ideal since it does not easily facilitate alignment of the mutually opposed waveguides. This is because the reference shelf 20 of prior art VCLs 17, and in particular its thickness and its angle with respect to the optical axis, is difficult to manufacture reproducibly and with sufficient accuracy, meaning that alignment in the z-direction (i.e. the out-of-plane direction) of the mutually opposed waveguides is difficult. As the skilled person will appreciate, improper alignment provides poor touch sensitivity or may even ruin all ability to sense a touch event.

This disclosure overcomes or ameliorates at least one of the disadvantages of the prior art, and provide useful alternatives

An optical system is disclosed that comprises: a plurality of waveguides on a substrate, and a unitary collimating lens element on the substrate and adjacent the waveguides, the lens element being optically coupled to the plurality of waveguides.

The disclosed optical system provides reduced complication in installation, improved alignment of optical components and relatively reduced manufacturing costs. The disclosed optical system may be distinguished from the prior art in that a plurality of waveguides are adapted to direct a plurality of optical signals into a single unitary collimating lens element, and wherein the collimating lens element and the waveguides are all positioned, formed or configured on a common substrate which provides a common optical axis. The preferred substrate comprises a uniform support surface which acts as a mechanical and optical datum for the various system components. It will be clear to the skilled person that such a configuration provides significant improvements in optical alignment in the z-axis, as well as tilt about the x and y axes. Furthermore, when the disclosed optical system is fabricated on a single substrate having both transmit and receive sides of an optical touch system, alignment in the remaining three degrees of freedom (x and y axes and tilt about the z axis) is additionally provided. That the collimating lens element and the waveguides may be manufactured simultaneously, further reducing assembly complications and improving optical alignment issues

In one embodiment, a plurality of divergent optical signals are produced by the waveguides and directed to the lens element. The lens element is preferably adapted to receive and transform the plurality of divergent optical signals into a corresponding plurality of collimated optical signals which are launched across the touch input area, thereby creating a plane of illumination above a display device. In this embodiment, the configuration is adapted to be a transmit side of a touch screen system. The substrate may define a plane and the collimated optical signals propagate substantially parallel to the plane.

In the “reverse” case, where the configuration is adapted to be a receive side of a touch screen system, the unitary collimating lens element is adapted to receive a plurality of collimated optical signals (whether in the form of discrete beams or a continuous sheet of light) and transform and transmit the collimated signals as a respective plurality of convergent signals which are preferably incident upon the waveguides. This may be achieved by appropriate shaping and configuration of the lens element as well as effecting a predetermined spacing between the lens and waveguides

In use, a plurality of collimated optical signals in the form of discrete beams or a continuous sheet of light are launched across the touch input area and are received by the mutually opposed lens element and receive waveguides. The optical touch system awaits any interruption of the beams of light within the plane overlying the screen. A series of busses returns the illumination to a plurality of sensors An interruption in the received signal is interpreted as a “touch” by a receiver chip which can then uniquely identify the location of the touch by the x/y coordinates of the beams that are being interrupted.

The disclosed lens may focus/collimate any number of incident optical signals, and the greater the number of optical signals employed the greater the degree of touch position accuracy. Injection molding or micro-fluid-resin casting, UV embossing and other methods may be used to create relatively quickly and inexpensively lenses suitable for use in accordance with this disclosure. Injection molding or UV embossing may be used to create the lens

The waveguides may terminate in a planar lens adapted to collimate light in the plane of the substrate. However, it will be appreciated that the planar lens may not be required, and the unitary collimating lens could be adapted to provide both horizontal and vertical collimation by providing an array of shaped lens portions on the unitary lens, wherein each of the shaped lens portions corresponds to a waveguide. However it will be appreciated that in this embodiment the waveguides would need to be aligned with the array of shaped lens portions, a requirement readily satisfied by at least some of the fabrication/assembly techniques described in this specification.

The physical height of the collimating lens element is typically from about 10 to about 1000 times the physical height of the waveguides or the planar lens. For example, the height of a typical waveguide is from about 5 to about 20 microns, and a collimating lens from about 0.05 to about 2 mm in height. The collimating lens element may be 0.05, 0.1, 0.15, 0.2, 0.25, 0.3, 0.35, 0.4, 0.5, 0.55, 0.6, 0.65, 0.7, 0.75, 0 8, 0.85, 0.9, 0.95, 1.0, 1.05, 1 1, 1.15, 1.2, 1 25, 1.3, 1.35, 1 4, 1.45, 1.5, 1.55, 1.6, 1.65, 1.7, 1.75, 1.8, 1.85, 1.9, 1.95 or 2 0 mm in height.

The unitary collimating lens element is at least partially positioned adjacent an input area of an input device. In one aspect the input area is defined by a plurality of sides and the unitary collimating lens element extends around adjacent sides of the input area of the input device. In most common embodiments, the input area is rectangular and the collimating lens element is adapted to frame and surround the rectangular input area. However, in alternative embodiments the unitary collimating lens element may be annular or circular in shape and surround the input area, which may itself be annular or circular in shape, or even rectangular.

In one embodiment, the substrate is a substantially rectangular plate, wherein the region of the rectangular plate surrounded by the unitary collimating lens element, which is in the form of a “frame”, defines the input area of the input device. This region could serve as a display protector for protecting an underlying LCD display, and can also serve to strengthen the resulting mechanical assembly. In this case clearly the substrate must be transparent. In other embodiments wherein the substrate is similarly shaped to the unitary lens, i.e. shaped as a frame, the substrate does not necessarily need to be transparent. This enables a broader range of material choices that can add value to mechanical performance. The advantages of this “flame” example are that light is obviously not blocked, attenuated or “colour-shifted”, nor is there any video display image degradation of an underlying video display, such as a LCD.

In one embodiment, the plurality of waveguides and the unitary collimating lens element are produced simultaneously on or with the substrate. In a related embodiment the waveguides are integral with the collimating lens element, however, in an alternative embodiment the waveguides may be in physical connection with the collimating lens element. The collimating lens element may or may not be integral (i.e. continuous) with the substrate.

In an alternative embodiment the plurality of waveguides and the unitary collimating lens element are produced separately and attached to the substrate. In order to facilitate correct positioning of the unitary collimating lens element on the substrate the collimating lens element may include a positioning formation for engagement with a complementary formation on the substrate. For example the positioning formation may be a projection, a slot or a recess and the substrate may be manufactured with a complementary formation, such as a slot, a ridge or a protrusion. In preferred embodiments the collimating lens element is adapted for irreversible press-fit engagement with the substrate. In the case wherein the unitary collimating lens element and the plurality of waveguides are produced separately and then attached to the substrate, various means are available fox the attachment process, as the skilled person will readily appreciate. For example, waveguides and/or the collimating lens element may be attachable to the substrate by use of double sided tape, light cured adhesive, thermal adhesive, pressure sensitive adhesive or chemically cured adhesive.

A key problem for manufacturing low cost, high volume, commercially viable optical touch systems in the prior art is the large number of assembly tolerances that result when discrete components are brought together and integrated in the assembly process that creates the optical touch sensor system. The disclosed optical systems surprisingly avoid these problems by providing a common reference surface upon which the various system components are either engaged to, or formed upon. Namely, the disclosed optical systems result from attaching various system components to the common substrate, and simultaneously forming the waveguides and/or the collimating lens element either together and attaching to the substrate or integrally with the substrate. The various system components are disposed upon a common substrate that provides an optical, and optionally a mechanical, datum.

In related embodiments, a cladding or waveguide substrate layer may be utilised between the waveguides and the substrate. The skilled person would realise that the waveguides may include such a layer, which may be utilised for a variety of reasons, for example if the substrate is absorbing or has a refractive index higher than that of the waveguides (those skilled in the art will understand that to guide light, the waveguides need to be in contact with a material of lower refractive index). In other examples, this additional layer provides optical alignment of an optical axis of the waveguides with an optical axis of the collimating lens element This embodiment allows the collection of more of the optical signal strength into the lens.

A disclosed method for producing a plurality of optical signals comprises: providing a plurality of waveguides on a substrate, providing a unitary collimating lens element on the substrate and positioned adjacent the waveguides, the lens element being optically coupled to the plurality of waveguides to transmit or receive a plurality of optical signals to or from the waveguides.

According to a third aspect, a disclosed method for producing an optical system, comprises: providing a plurality of waveguides on a substrate, providing a unitary collimating lens element on the substrate and positioning the lens element adjacent the waveguides such that the lens element is optically coupled to the plurality of waveguides.

According to a fourth aspect, a disclosed collimating lens element for an optical system, comprises: a unitary non-linear elongate lens body adapted for attachment to a substrate and for optical coupling to a plurality of waveguides, the lens body sized to transmit or receive a plurality of optical signals to or from the waveguides.

The lens may be molded by any number of means as a solid piece of glass, resin or other suitable light-bending material. In one embodiment, four full-display-length (or width) lenses are used, a pair for the top and bottom of the display and a pair for the left and right side of the display. Depending on the sources of light and the sensors, one lens is placed vertically and one lens is placed horizontally for transmitting beams of light. Two other lenses are placed vertically and horizontally for receiving the transmitted beams. In other embodiments the lenses are a pair of L-shaped lenses for receive and transmit sides respectively. In yet further embodiments a single lens is provided which is shaped as a frame, e.g a rectangular frame wherein a pair of adjacent sides of the frame define the transmit side and the remaining pair of adjacent sides define the receive side. Alternatively, the signal light may be generated by some non-waveguide means (e.g. the faceted light pipe of U.S. Pat. No. 7,099,553), in which case the lens/waveguide systems of the present invention are only required on the receive side.

In one embodiment the collimating lens element comprises a plurality of elongate linear lens elements. However, in another embodiment the collimating lens is at least partially arcuate in plan view.

The collimating lens element is adapted for attachment to the substrate. In one embodiment the base surface of the lens is planar and may be glued etc, however, in other embodiments the base surface comprises one or more recesses which serve as “glue-fillets” These recesses can assist in enabling a consistent adhesive “bond-line” between the base surface and the surface to which it is attached during its assembly. These recesses can, in addition, help prevent bubbles from being trapped between the lens-to-substrate interface, and they can assist in reducing the possibility of excess adhesive displacement to unwanted areas of the substrate to which this lens is attached.

The lens can also include raised surfaces or structures on its base surface that enable mechanical coupling to the substrate during assembly. These mechanical structures can serve as reference structures to assist in positioning the lens such that a predetermined distance is established between the various system components, thereby optically aligning the system. In this way, the lens can be transferred to its desired position on the substrate with less costly processing approaches including manual approaches enabled by mechanical references. Kinematic structures can also be used to enable kinematic coupling of the lens to a position on the substrate. Press Fit attachment of the lens based on alignment posts or “bosses” to smaller holes or recesses in the substrate is also possible.

The lenses can be manufactured more easily, with higher tolerances and lower cost than vertical lens designs in the prior art. Because the alignment of the lenses to other optical system elements is based on a common reference surface for all optical system components, they do not have to provide a reference surface for the waveguides—as in prior art embodiments where the vertical collimating lens provides an opto-mechanical reference for polymer waveguide systems, for example as shown in FIG. 2. The need to provide a mechanical reference, by design, for the polymer waveguide systems, where polymer waveguide systems are actually aligned to vertical lenses, in prior art embodiments, can make the vertical lens very difficult to manufacture. The complexity in the mold insert design for injection molded lenses in the prior art can be very complex, difficult to verify, and relatively costly. The disclosed lens design is relatively simple to manufacture by comparison, and in the injection molding case, the insert systems required are relatively simpler and less costly to make. Lens conformance to specification is easier to verify.

As indicated previously, the lenses can be fabricated with injection molding more easily and with tighter tolerances and at lower cost than other competing tens types and designs in the prior art. In addition, variants of the lens can be fabricated using liquid resin molding of reactive and photosensitive materials—and can be cured with light, chemistry, or heat, in a curing process. Other molding technologies can be used to manufacture these lens types more easily than other lens types because of the nature of their cross-sections and the inherent ability of the cross-sectional shapes to be removed from mold cavities. The disclosed lenses can be made out of a wide variety of optical materials and processes including but not limited to polycarbonate, PMMA, cyclic polyolefin, Zeonex, Zeonor, Topas, polystyrene, polyurethanes, polysiloxanes, acrylic materials, polynorbornenes, styrene-acrylo-nitrile, and other plastics and polymers. The disclosed lenses may also be at least partially extruded.

Preferably the lens comprises a draft angle enabling release of the injection molded part without interlocking. However, the skilled person will appreciate that molded parts with re-entrant portions may be fabricated if required, e.g with two interlocking mold parts

According to a fifth aspect, a disclosed collimating lens element for an optical system, comprising: a unitary elongate lens body adapted for attachment to a substrate and for optical coupling to a plurality of waveguides, the lens body sized to transmit or receive a plurality of optical signals to or from the waveguides, and wherein the lens body includes a positioning formation for engagement with a complementary formation on the substrate.

According to a sixth aspect, a disclosed method for production of an optical system comprises: providing a mold having a plurality of first grooves adapted to produce a plurality of waveguides, and a second groove positioned adjacent the first grooves and adapted to produce a unitary collimating lens element, filling the grooves with an optically transparent material, curing the optically transparent material, and demolding the resultant optical system, whereby the lens element is optically coupled to the respective plurality of waveguides.

In one aspect the second groove is linear. In an alternative aspect the second groove is non-linear. In a related aspect the second groove comprises a plurality of linear portions. Alternatively the second groove may be annular in plan view. Preferably the unitary collimating lens element is produced having a positioning formation for engagement with a complementary formation on the substrate, wherein the positioning formation is a projection, a slot or a recess.

According to a ninth aspect, a disclosed optical touch system, comprises: a first plurality of waveguides on a substrate defining a first waveguide allay, and a second plurality of waveguides on the same substrate defining a second waveguide array, the first and second waveguide arrays being spaced apart, the first waveguide array being adapted to transmit a plurality of optical signals and the second waveguide array being adapted to receive the plurality of optical signals, and a pair of unitary collimating lens elements, each the lens element being positioned adjacent and optically coupled to a respective waveguide array for respectively transmitting and receiving collimated optical signals to and from a respective waveguide array. Preferably the system comprises a plurality of first and second waveguide arrays.

In relation to the ninth aspect, it will be appreciated that when a total of four waveguide arrays are provided (two transmit and two receive), four unitary collimating lens elements may be utilised, with each lens element being adjacent a respective waveguide array In an alternative yet related aspect, instead of utilising foul unitary collimating lens elements a pair of L-shaped collimating lens elements may be utilised In a further alternative yet related aspect, instead of utilising four unitary collimating lens elements a single frame-shaped collimating lens element may be utilised, wherein the frame-shaped collimating lens element may be adapted such that each side of the “frame” is adjacent a respective waveguide array. It will be appreciated that this embodiment inherently establishes a precision z-axis relationship between the system components since they are all disposed or configured on a common, substantially flat substrate.

According to a tenth aspect, a disclosed apparatus, comprises: a light source; a substrate; a transmission waveguide portion optically coupled to receive light from the light source and disposed on the substrate, the transmission waveguide portion having a first plurality of light transmission waveguides that produce a first set of light beams by guiding the light received from the light source so that the first set of light beams emanates from the first plurality of light transmission waveguides in a first direction; a reception waveguide portion spaced apart from the transmission waveguide portion in the first direction and disposed on the substrate, the reception waveguide portion having a first plurality of light reception waveguides for receiving the first set of light beams emanating from the light transmission waveguides; and a light detector optically coupled to the reception waveguide portion to receive the light from the first plurality of light reception waveguides of the reception waveguide portion, the light detector including a plurality of light detecting elements that substantially simultaneously detect the intensity of the light from the first plurality of light reception waveguides of the reception waveguide portion; wherein the transmission waveguide portion and the reception waveguide portion each have a respective a unitary collimating lens element adjacent and optically coupled thereto, the lens elements being on the substrate.

As discussed in the foregoing, the disclosed optical systems and methods of manufacture introduce the concept of a polymer waveguide “frame”, which provides for optical alignment of the mutually opposed pairs of waveguides (transmit and receive). This is achievable by printing the transmit and receive waveguides at the same time and on the same substrate For example, using a masked based photolithography process, this frame would be achieved by designing it onto the photomask itself so that the features of the printed waveguide frame are delivered to its substrate with mask based accuracy and precision This method offers advantages over the prior art by “pre-aligning” the transmit and receive waveguides during the waveguide fabrication process, thereby avoiding a relatively costly pre-alignment step as pet prior art L-shaped waveguides.

The polymer waveguide “frame” enables a planar optical system aligned in the x, y, and z directions, and the disclosed optical system is completed when a unitary lens is either attached to or formed with the substrate.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### BRIEF DESCRIPTION OF THE DRAWINGS

Certain embodiments will now be described, by way of example only, with reference to the accompanying drawings in which:

FIG. 1 illustrates a typical prior art waveguide-based optical touch screen sensor;

FIG. 2 is a cross section through typical prior art VCLs for the apparatus shown in FIG. 1;

FIG. 3 is an example of a light path through a disclosed optical system;

FIG. 4 shows cross-sectional views of various collimating lenses;

FIG. 5 is a view similar to FIG. 3 showing light paths through various lenses shown in FIG. 4 (note that the waveguides are integral with the collimating lenses on the transmit side of the third embodiment, and the waveguides are in physical connection with the lenses on the receive side of the third embodiment);

FIG. 6 shows various configurations for the disclosed collimating lens elements i.e. “straights”, L-shaped and frame-shaped;

FIG. 7 is a plan view of a disclosed optical input device;

FIG. 8 is a three dimensional rendering of one disclosed embodiment of an optical system;

FIG. 9 shows close-up views of an actual production model of the embodiment shown in FIG. 8;

FIG. 10 shows close-up views of three dimensional renderings of other embodiments of a disclosed optical system;

FIG. 11 shows the attachment of lens elements to a substrate comprising a plurality of waveguides;

FIG. 12 shows cross sections through lens elements and illustrating various positioning formations;

FIG. 13 shows the attachment of lens elements having a positioning formation to a substrate;

FIG. 14 shows an optical system wherein the substrate is continuous and the region between the lens elements defines a touch input area;

FIG. 15 is a view similar to FIG. 14 but wherein the substrate is discontinuous, i.e. is frame shaped having a central open portion;

FIG. 16 is a view similar to FIG. 15 but showing the lens element integral with the substrate;

FIGS. 17A and B show prior art transmit and receive waveguide structures, and FIG. 17C shows pre-aligned transmit and waveguide structures;

FIG. 18 shows the combination of a lens element with the pre-aligned transmit and receive waveguide structures shown in FIG. 17C to provide an optical touch input device;

FIGS. 19 and 20 are similar to FIG. 18 but showing the use of other embodiments of lens elements;

FIG. 21 shows the combination of L-shaped lens elements with L-shaped transmit and receive waveguide structures to provide an optical touch input device;

FIG. 22 shows various mold embodiments and the resultant molded optical systems;

FIG. 23 shows a molded substrate and waveguide array and the attachment of a lens element to provide an optical system according to the present invention; and

FIGS. 24 and 25 show an optical touch system in combination with electrical circuitry to provide a touch input device.

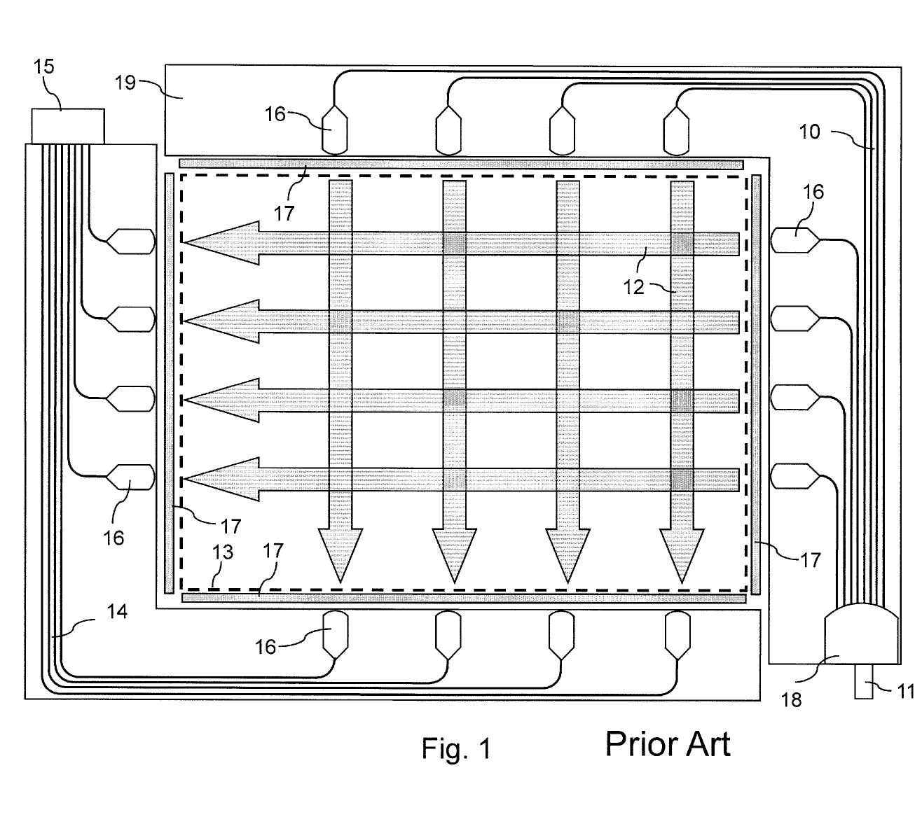

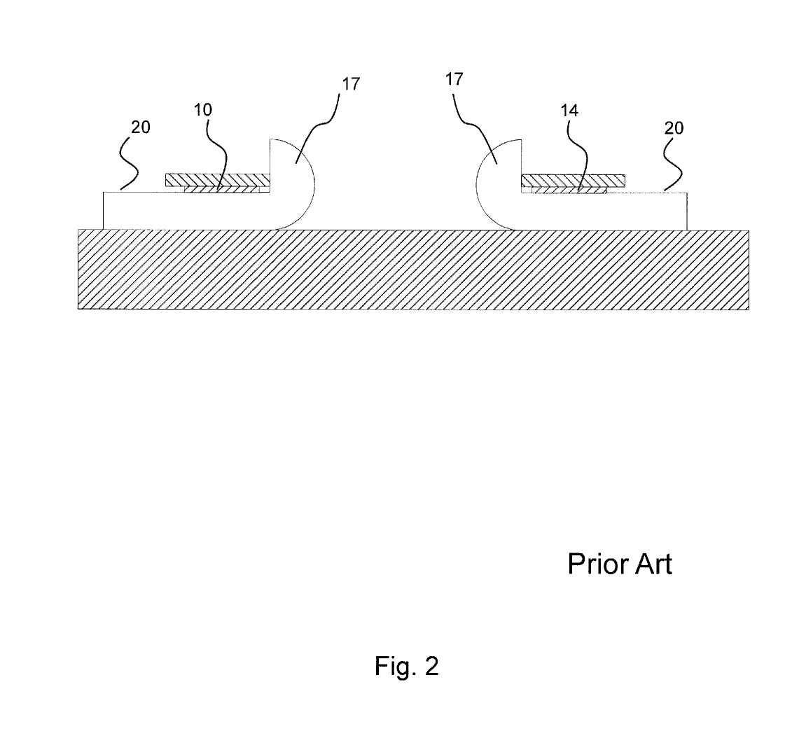

### DEFINITIONS

In describing and claiming the disclosed optical systems and related methods of producing the same, the following terminology will be used in accordance with the definitions set out below. It is also to be understood that the terminology used herein is for the purpose of describing particular embodiments only and is not intended to be limiting. Unless defined otherwise, all technical and scientific terms used herein have the same meaning as commonly understood by one having ordinary skill in the art to which the invention pertains.

The recitation of a numerical range using endpoints includes all numbers subsumed within that range (eg, 1 to 5 includes 1, 1.5, 2, 2.75, 3, 3.80, 4, 5, etc.).

The terms “preferred” and “preferably” refer to embodiments that may afford certain benefits, under certain circumstances However, other embodiments may also be preferred, under the same or other circumstances. Furthermore, the recitation of one or more preferred embodiments does not imply that other embodiments are not useful, and is not intended to exclude other embodiments from the scope of this disclosure.

### DETAILED DESCRIPTION OF THE PRESENTLY PREFERRED EMBODIMENTS

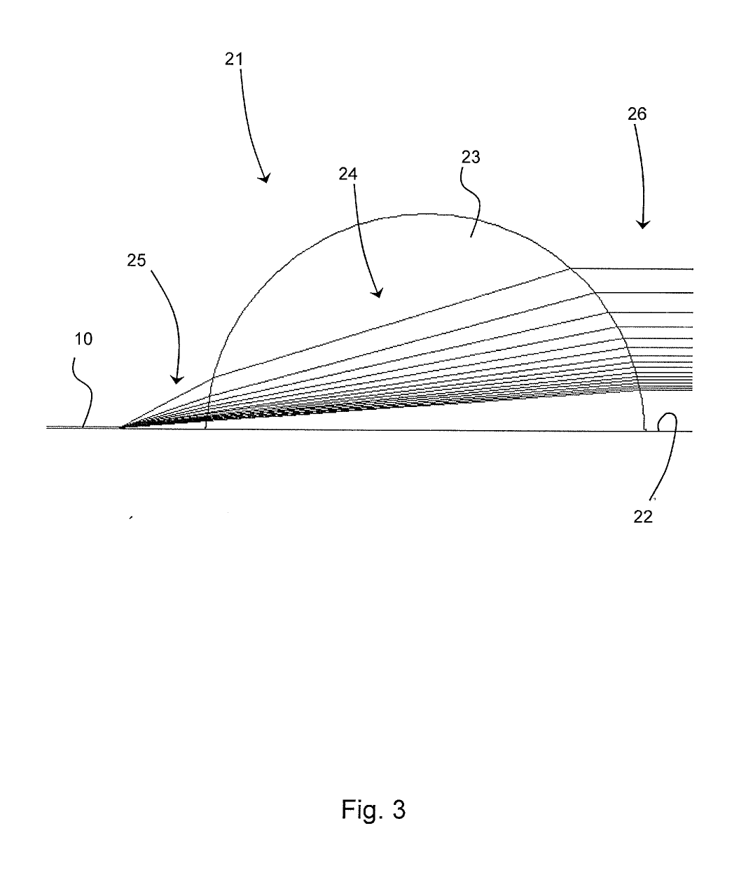

Reference will now be made to the drawings wherein like reference numerals refer to like parts or features throughout. FIG. 3 shows an optical system 21 comprising a plurality of waveguides 10 on a substrate 22, and a unitary collimating lens element 23 on the substrate 22 and adjacent the waveguides 10 (since FIG. 3 is a cross sectional view only a single waveguide is shown). The lens element 23 is optically coupled to the plurality of waveguides 10. A typical “light path” 24 is shown in FIG. 3 in which each waveguide 10 produces a divergent optical signal 25 directed to the lens element 23, which receives and transforms the plurality of divergent optical signals 25 into a corresponding plurality of collimated optical signals 26 which are launched across a touch input area, thereby creating a plane of illumination above a display device In the embodiment shown in FIG. 3 the configuration is adapted to be a transmit side of a touch screen system. Preferably the substrate 22 defines a plane and the collimated optical signals 26 propagate substantially parallel to the plane. Each of the waveguides 10 preferably terminates in a planar lens 16 adapted to collimate light in the plane of the substrate 22. The physical height of the collimating lens element is typically about 1 mm in height making it about 100 times the physical height of the waveguides.

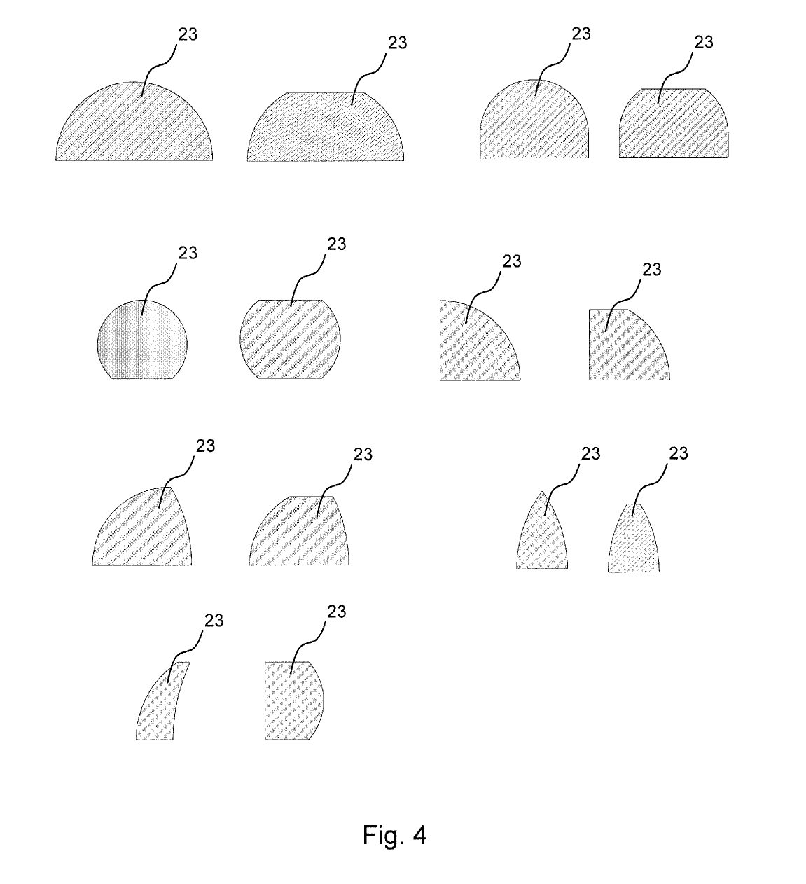

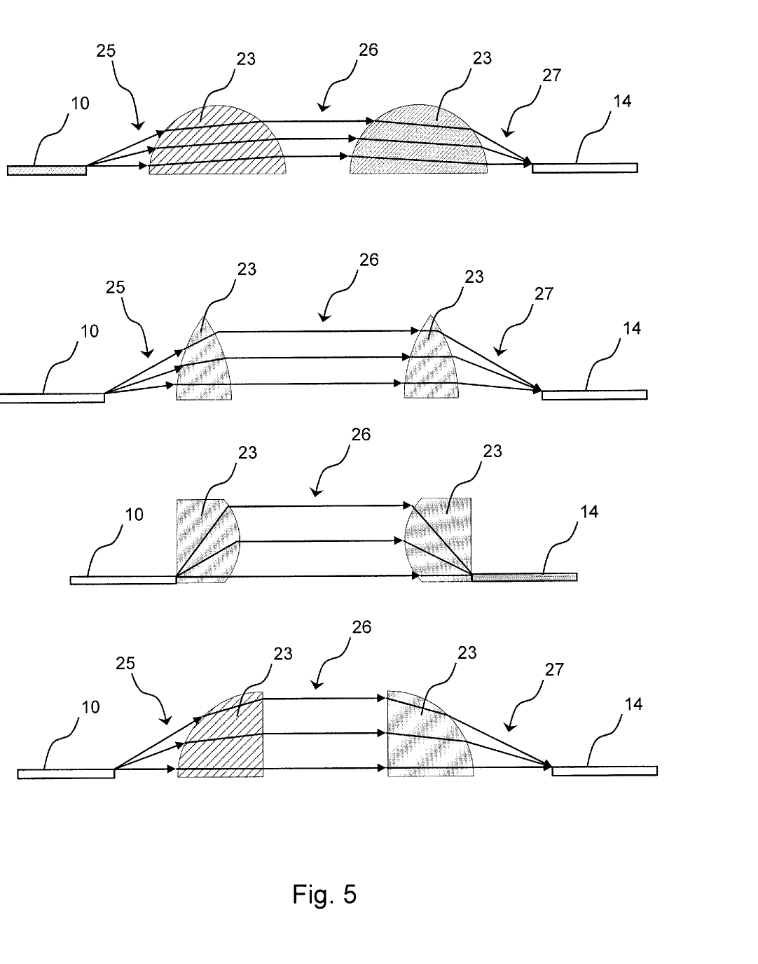

Referring now to FIGS. 4 and 5, cross-sectional views of various collimating lenses 23 are shown, their use in both transmit and receive sides of a touch screen system, as well as the light paths through the lenses 23 (the substrate 22 has been omitted in FIG. 5 for clarity). FIG. 5 also shows a disclosed optical system 21 being configured as a receive side of a touch screen system. In this case the unitary collimating lens element 23 is adapted to receive a plurality of collimated optical signals 26 and transform and transmit the collimated signals 26 as a respective plurality of convergent signals 27 which are incident upon the receive waveguides 14.

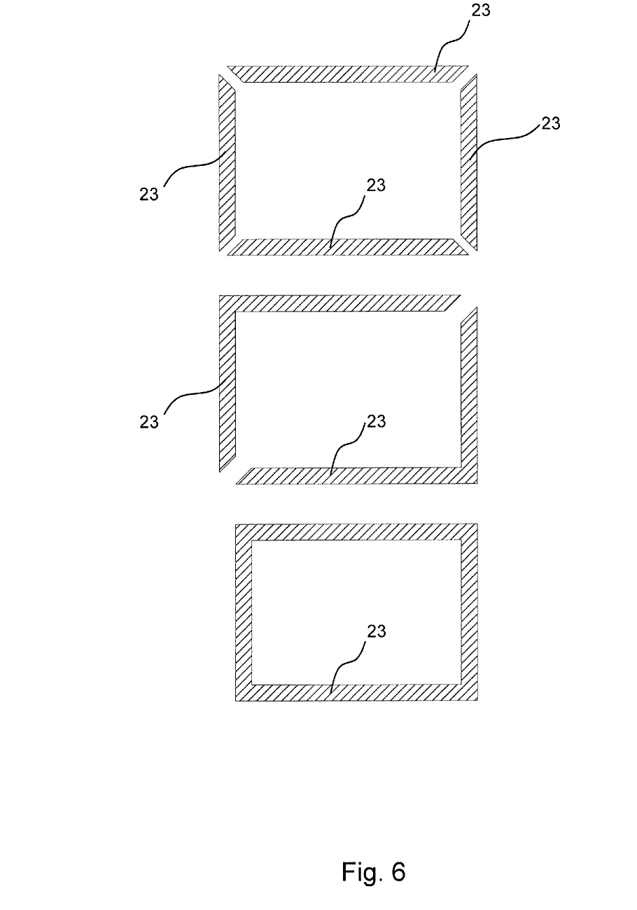

As discussed in the foregoing, the lens element 23 is preferably sized to transmit or receive the plurality of optical signals 25, 27, to or from the plurality of waveguides 10, 14. FIG. 6 shows various configurations for the collimating lens element 23, i.e. “straights”, L-shaped and frame-shaped. The lens 23 may be molded by any number of means as a solid piece of glass, resin or other suitable light-bending material. In the first embodiment, four full-display-length (or width) lenses are used, a pair for the top and bottom of the display and a pair for the left and right sides of the display. Depending on the sources of light and the sensors, one lens 23 is placed vertically and one lens 23 is placed horizontally for transmitting beams of light. Two other lenses are placed vertically and horizontally for receiving the transmitted beams.

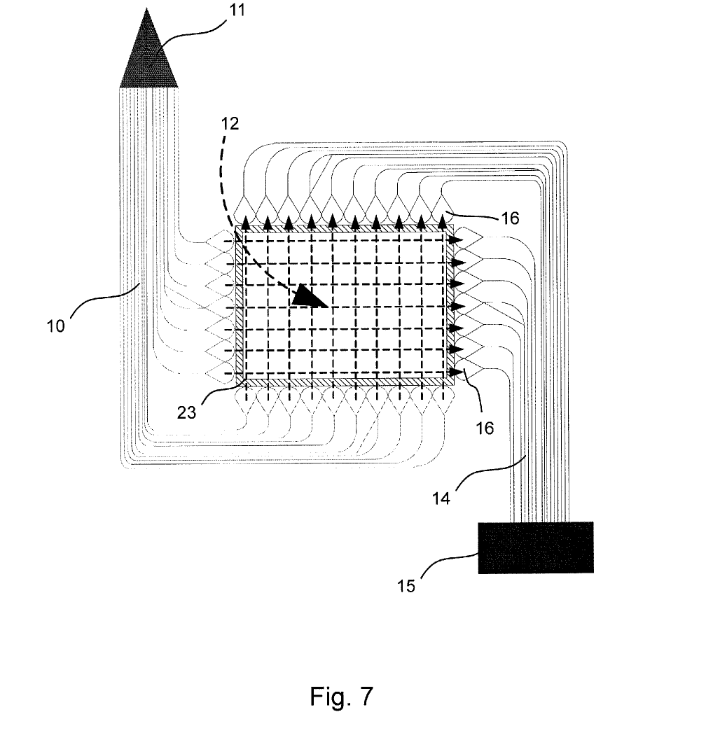

In the second embodiment shown in FIG. 6, the lenses 23 are a pair of L-shaped lenses for receive and transmit sides respectively, and in the third embodiment a single lens 23 is provided which is shaped as a frame, wherein a pair of adjacent sides of the frame define the transmit side and the remaining pair of adjacent sides define the receive side. By way of illustration, the frame shaped lens 23 is shown in use in optical input device as shown in FIG. 7.

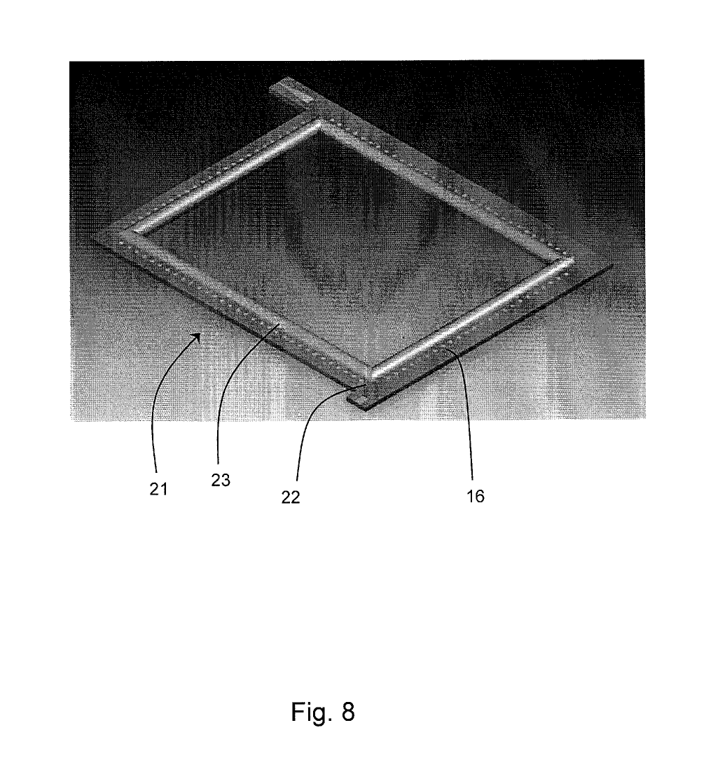

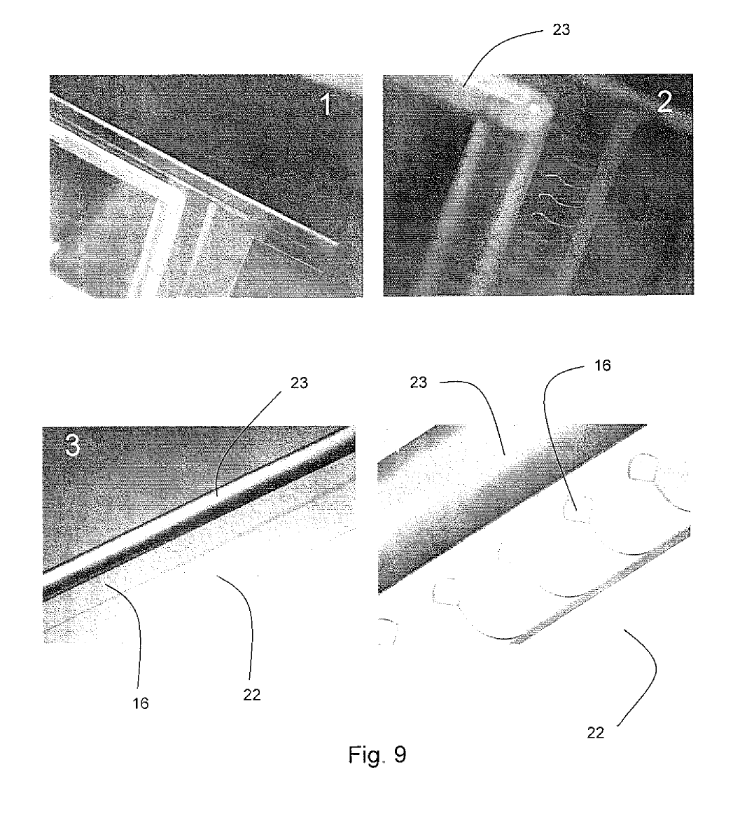

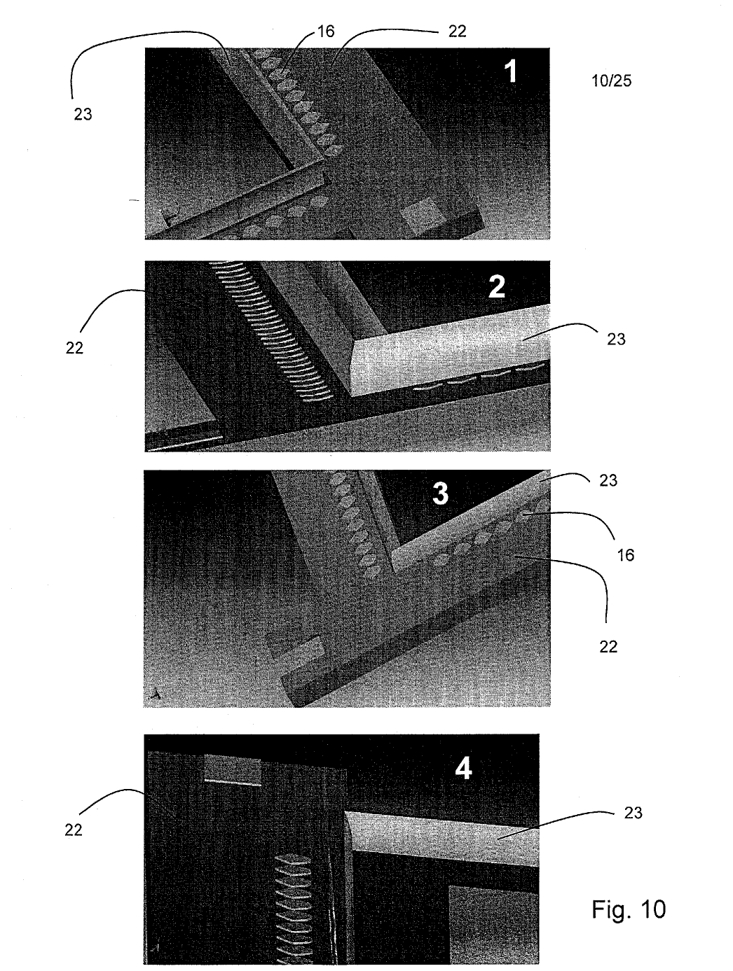

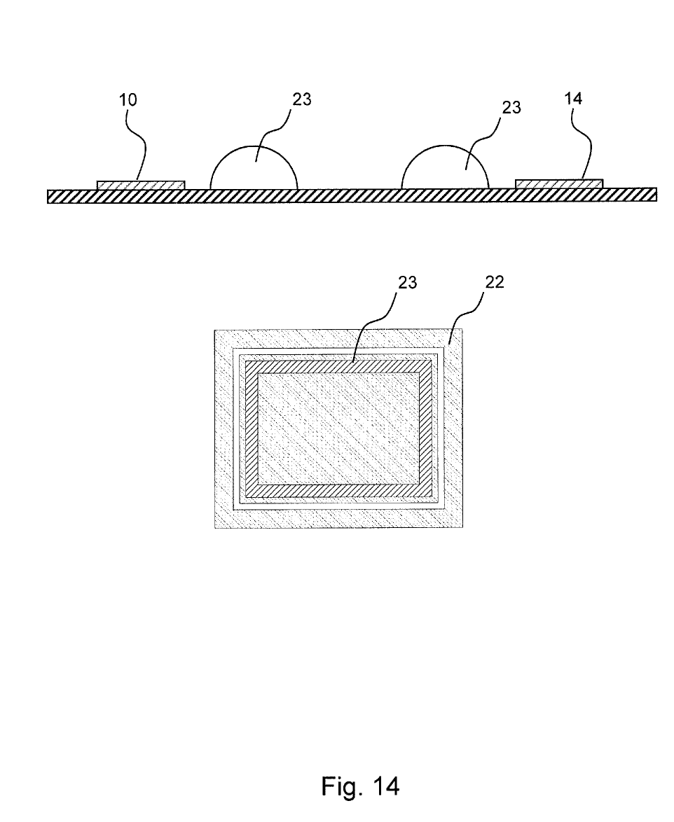

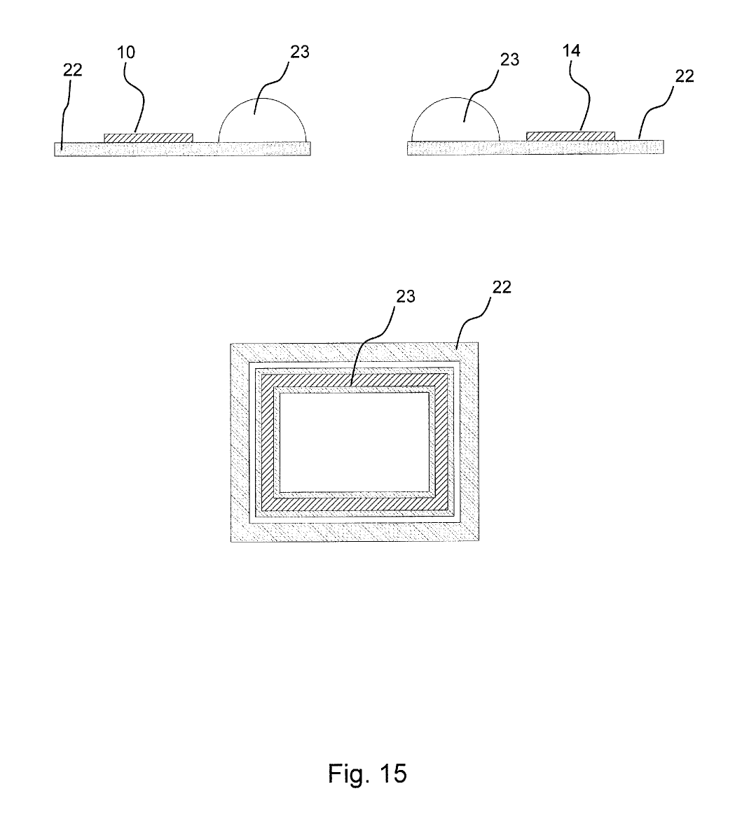

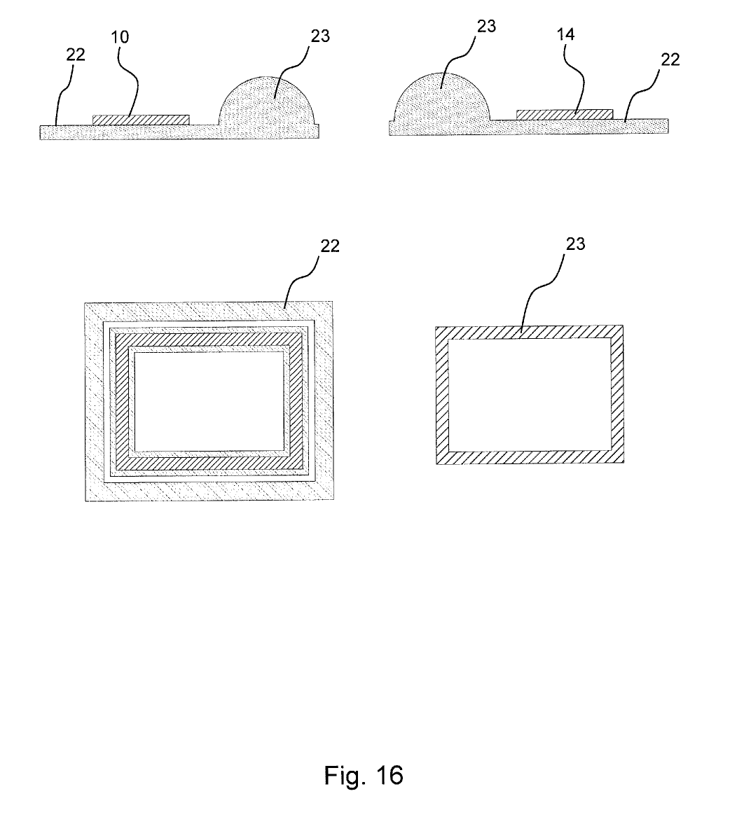

FIG. 8 is a three dimensional rendering of one embodiment of an optical system and FIG. 9 shows close-up views of an actual production model of the embodiment as shown in FIG. 8. FIG. 10 shows close-up views of three dimensional renderings of other embodiments of the disclosed optical system. In these embodiments the substrate 22 is similarly shaped to the unitary lens 23, i.e. shaped as a frame. However, the substrate 22 could be a substantially rectangular plate. Referring now to FIGS. 14 to 16, various configurations are shown. For example, FIG. 14 shows an embodiment wherein the substrate is continuous and the region between the lens elements defines a touch input area, FIG. 15 is a view similar to FIG. 14 but wherein the substrate is discontinuous, i.e is frame shaped, and FIG. 16 is a view similar to FIG. 15 but showing the lens element integral with the substrate

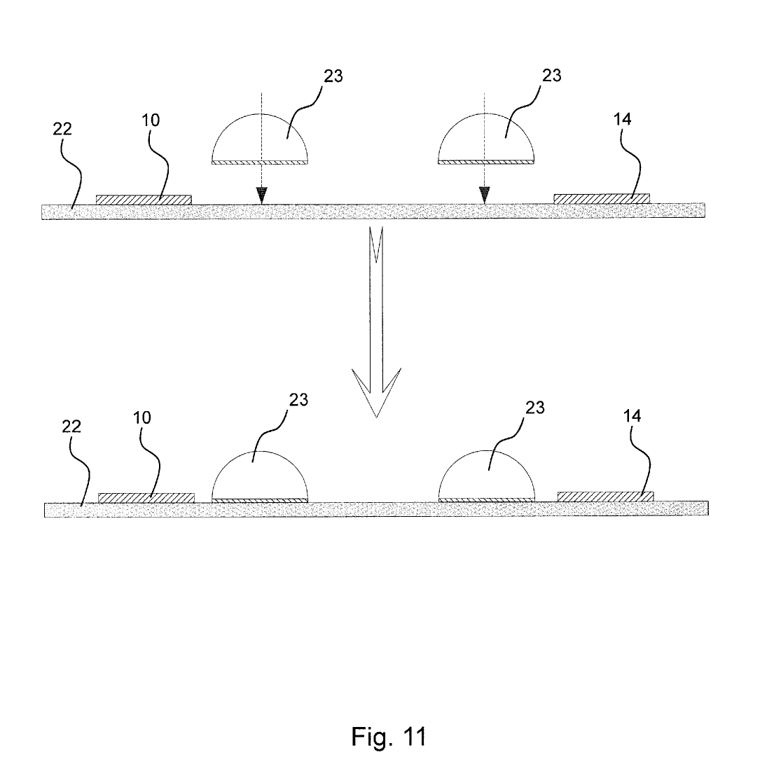

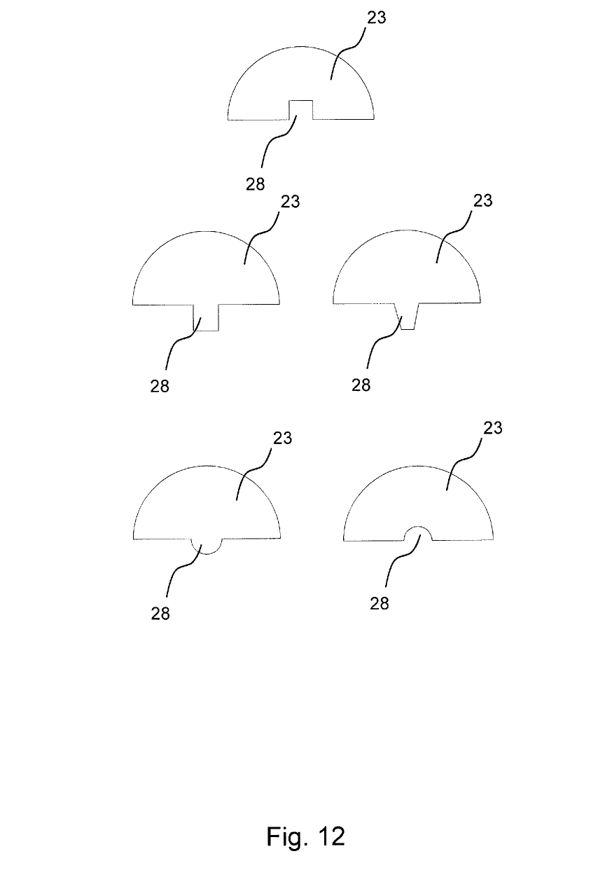

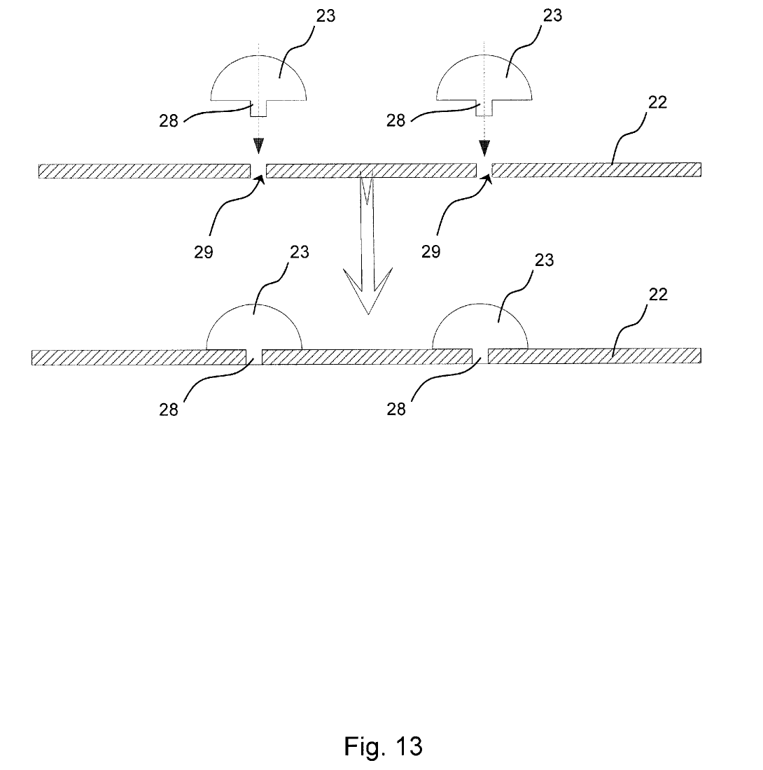

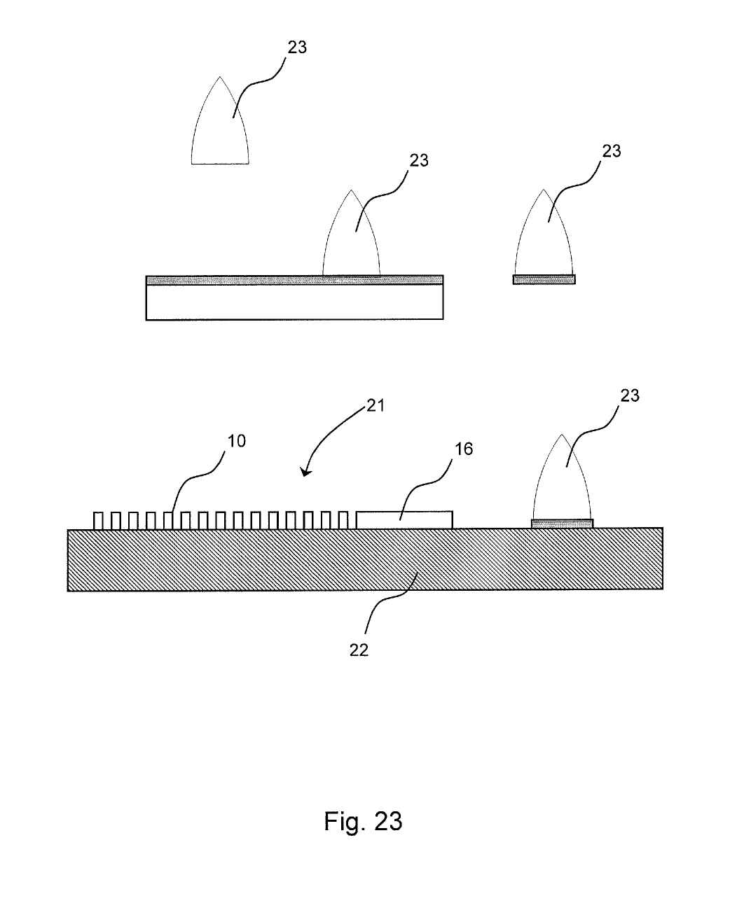

FIG. 11 shows the attachment of lens elements 23 to a substrate 22 comprising a plurality of waveguides 10, 14. In this embodiment, the waveguides 10, 14 and the unitary collimating lens elements 23 are produced separately and attached to the substrate. In older to facilitate correct positioning of the unitary collimating lens element 23 on the substrate 22 the collimating lens element 23 may include a positioning formation 28 for engagement with a complementary formation 29 on the substrate 22, as best shown in FIGS. 12 and 13. For example the positioning formation 28 may be a projection, a slot or a recess and the substrate 22 may be manufactured with a complementary formation 29, such as a slot, a ridge or a protrusion. In the case wherein the unitary collimating lens elements 23 and the plurality of waveguides 10, 14, are produced separately and attached to the substrate 22, various means are available to attach these system components to the substrate 22, as the skilled person will readily appreciate. For example, waveguides and/or the collimating lens elements may be attachable to the substrate 22 by use of double sided tape, light cured adhesive, thermal adhesive, pressure sensitive adhesive or chemically cured adhesive. For example FIG. 23 shows a molded substrate 22 and waveguide array 10 and the attachment of a lens element 23 to provide a disclosed optical system 21.

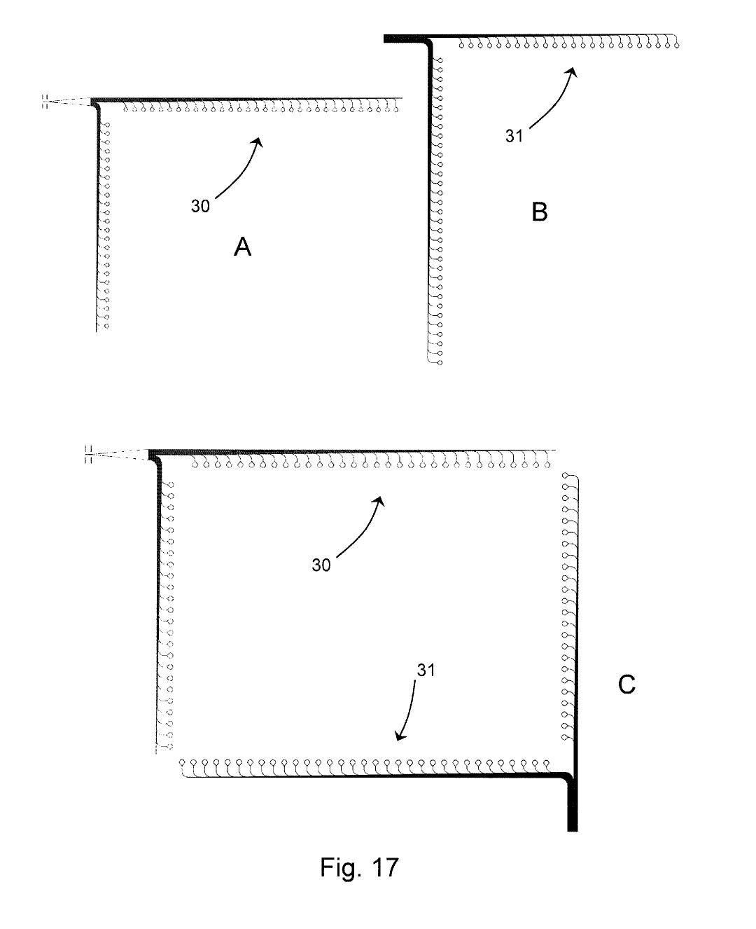

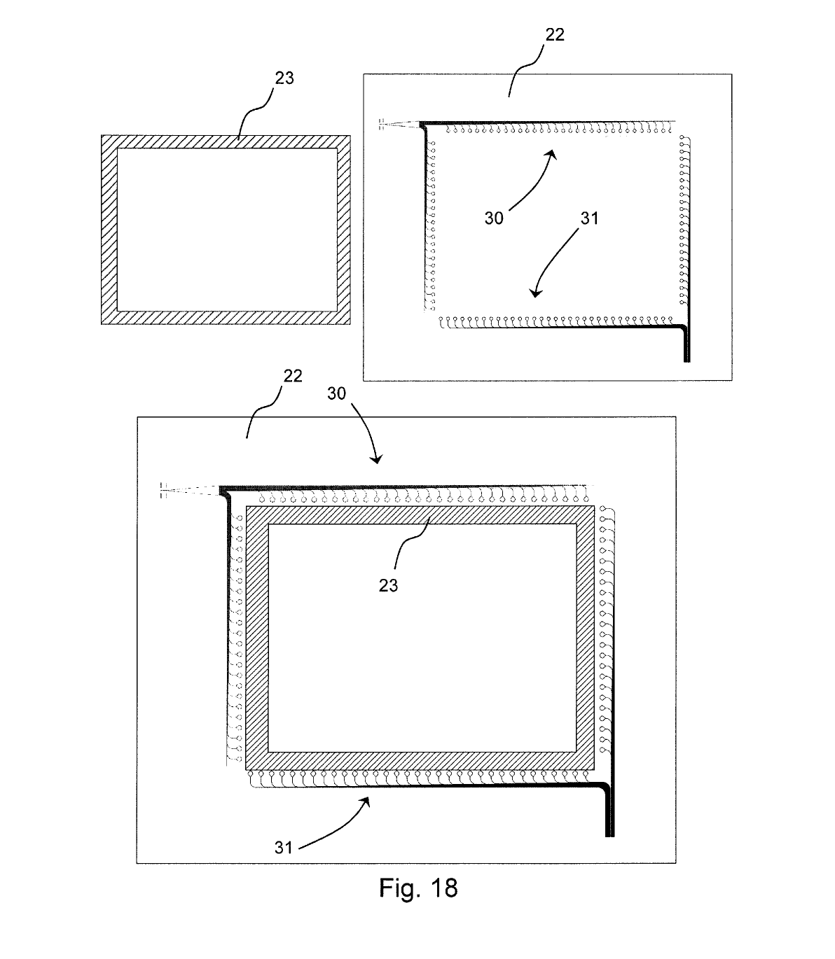

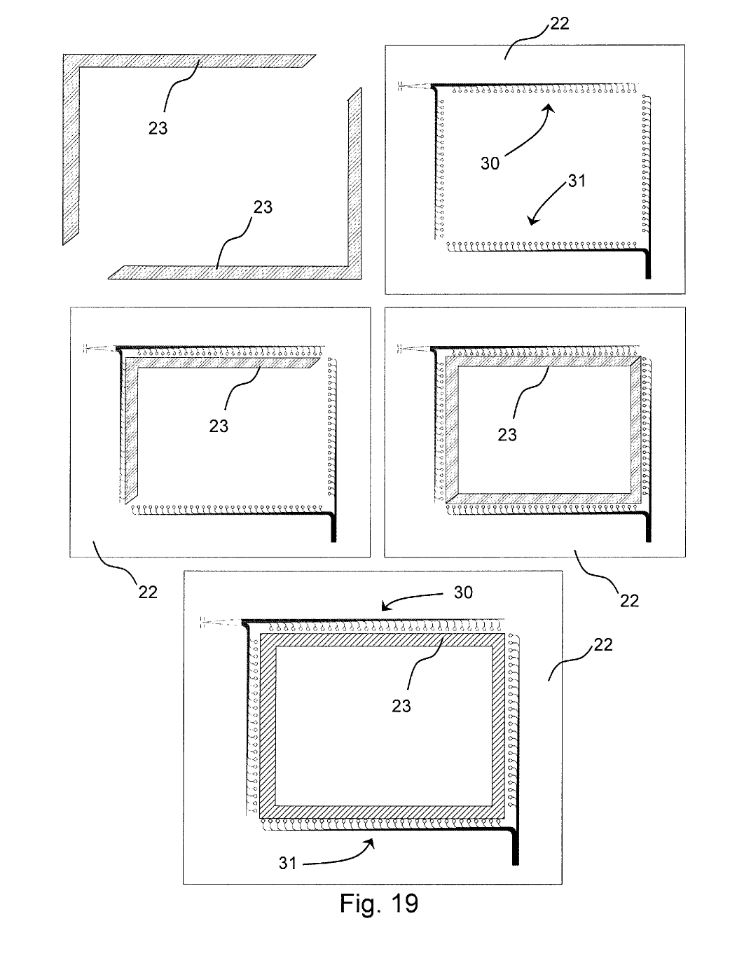

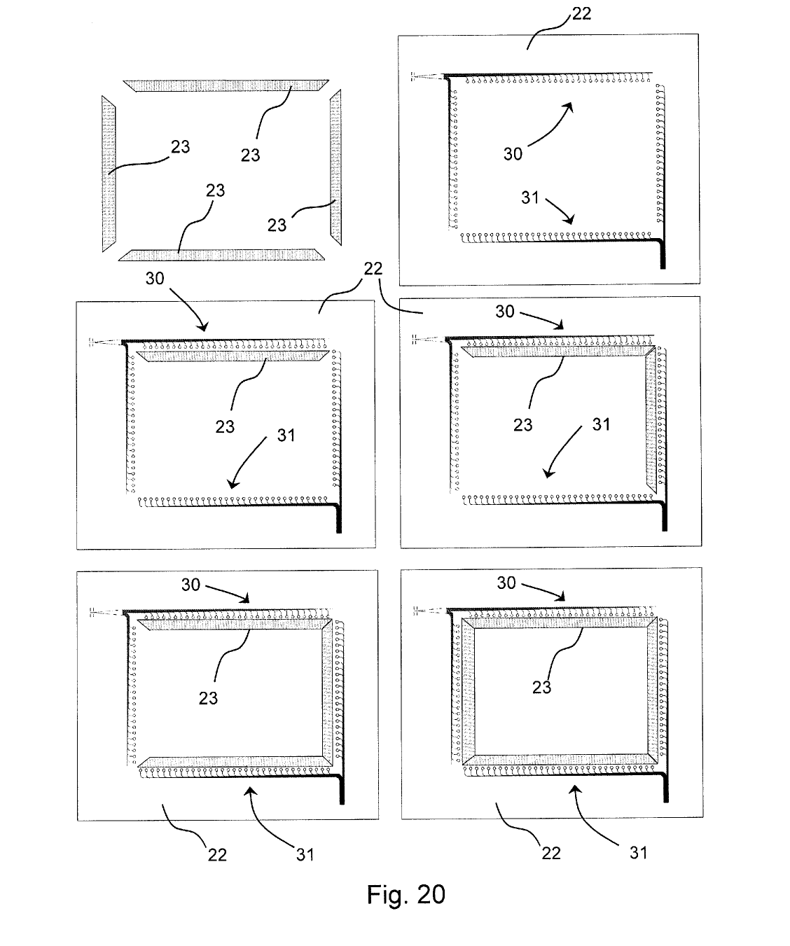

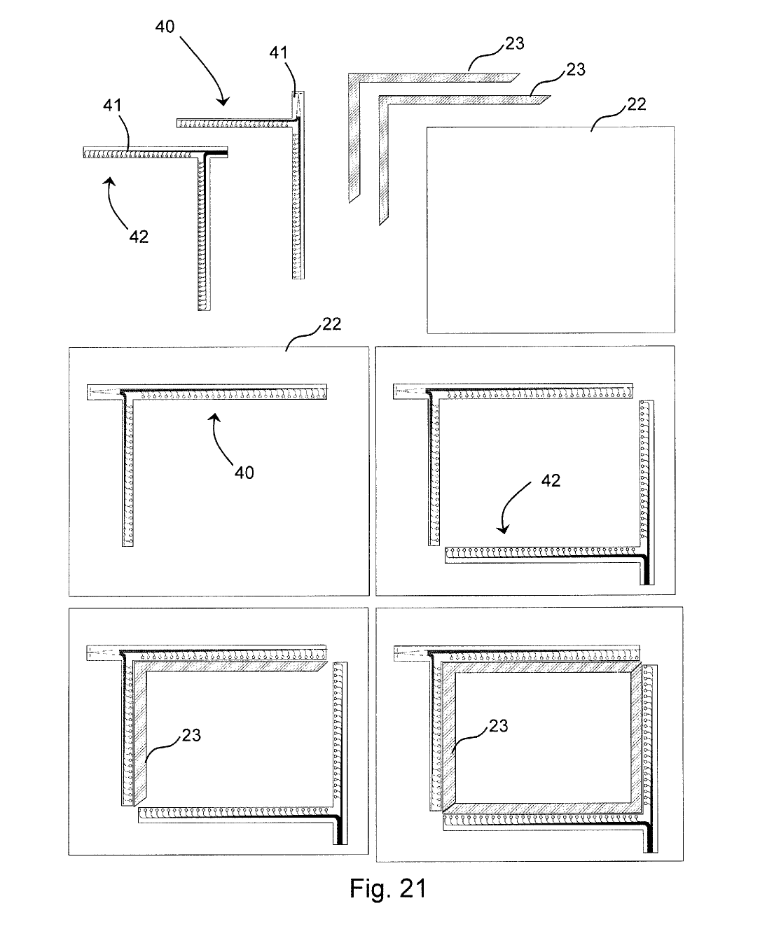

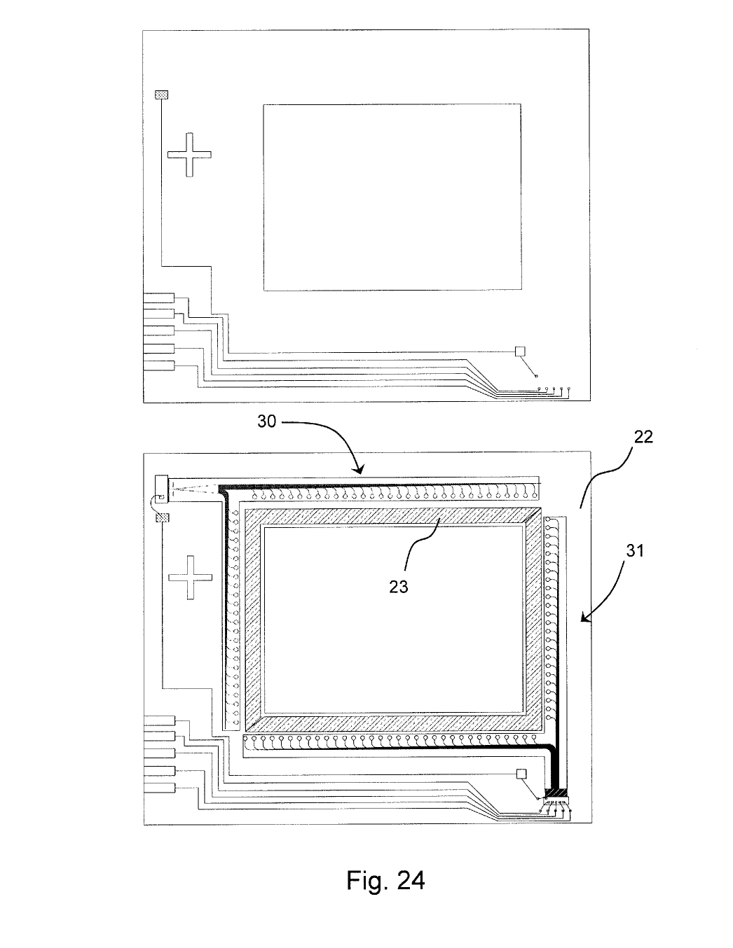

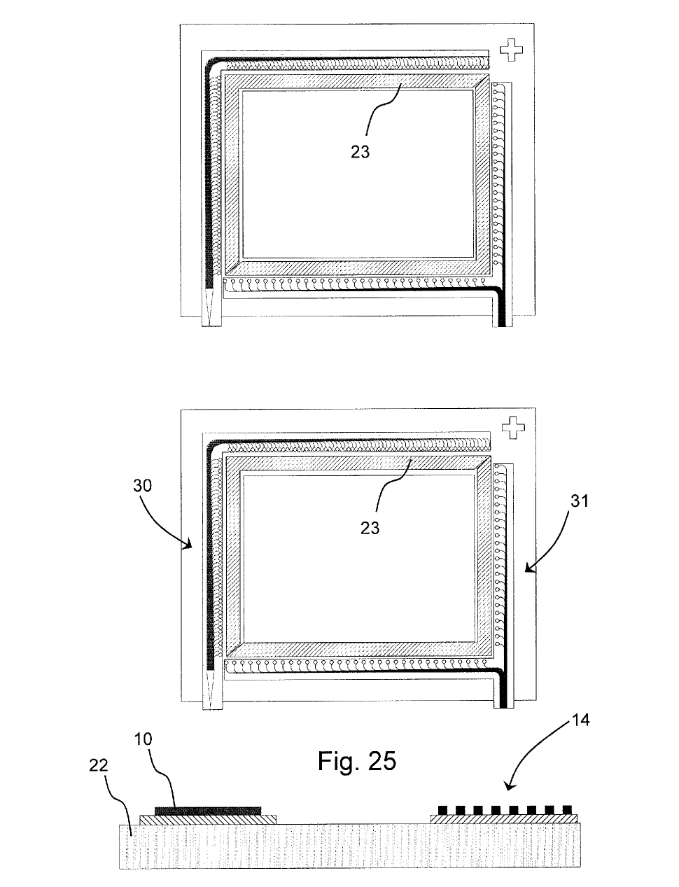

Referring now to FIGS. 17 to 21, and initially FIGS. 17A and B, prior art L-shaped transmit 30 and receive waveguide structures 31 are shown. However, FIG. 17C shows transmit and receive waveguide structures fabricated on the same substrate 22, thereby providing pre-alignment to the individual transmit-receive waveguide pairs. FIGS. 18 to 21 shows the combination of various lens elements 23 with the pre-aligned transmit and receive waveguide structures shown in FIG. 17C to provide an optical touch input device For example, FIG. 18 employs a frame-shaped lens 23, FIG. 19 employs a pair of L-shaped lenses 23, and four lenses 23 are employed in FIG. 20. FIG. 21 shows a transmit structure 40 formed on a waveguide substrate 41, a receive waveguide structure 42 formed on another waveguide substrate 41 and a pair of L-shaped lenses 23, all adapted to be positioned on a substrate 22. FIGS. 24 and 25 show optical touch systems, utilising the embodiments shown in FIGS. 17 to 21, in combination with electrical circuitry to provide a touch input device

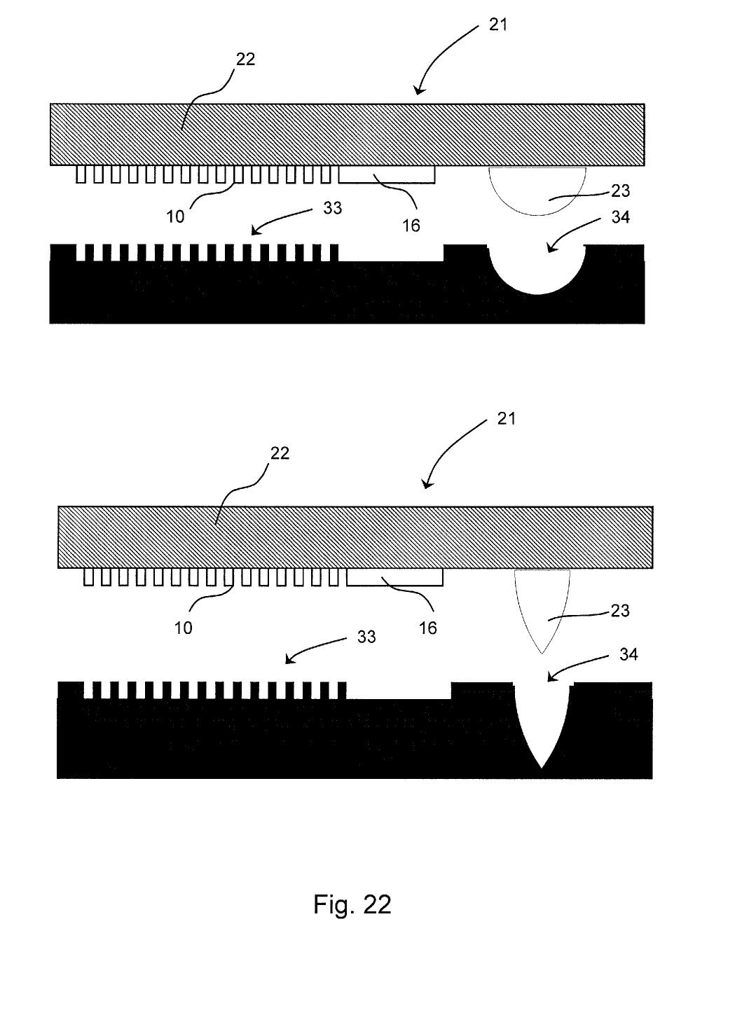

As shown in FIG. 22, a disclosed method for production of an optical system 21 comprises providing a mold 32 having a plurality of first grooves 33 adapted to produce a plurality of waveguides 10, 14, optionally with planar lenses 16, and a second groove 34 positioned adjacent the first grooves 33 and adapted to produce a unitary collimating lens element 23 The method then comprises the steps of filling the grooves 33 and 34 with an optically transparent material, curing the optically transparent material, and demolding the resultant optical system 21.

Although certain embodiments has been described with reference to specific examples, it will be appreciated by those skilled in the art that the disclosed optical systems and methods of producing the same may be embodied in many other forms. In particular features of any one of the various described examples may be provided in any combination in any of the other described examples

1. An optical system comprising:
a plurality of waveguides on a substrate; and
a unitary collimating tens element on the substrate and adjacent the waveguides, the lens element being optically coupled to the plurality of waveguides.

2. An optical system according to claim 1 wherein a plurality of optical signals are produced by the waveguides and directed to the lens element, and wherein the lens element is adapted to transform the plurality of optical signals into a corresponding plurality of collimated optical signals.

3. An optical system according to claim 1 wherein the unitary collimating lens element is adapted to receive a plurality of collimated optical signals and transform and transmit the signals to the waveguides

4. An optical system according to claim 1 wherein the substrate defines a plane and the collimated optical signals propagate substantially parallel to the plane.

5. An optical system according to claim 4 wherein each the waveguide terminates in a planar lens adapted to collimate light in the plane of the substrate.

6. An optical system according to claim 1 wherein a physical height of the collimating lens element ranges from about 10 to about 1000 times a physical height of the waveguides.

7. An optical system according to claim 1 wherein the unitary collimating lens element is adapted to flame and surround an input area of an adjacent input device.

8. An optical system according to claim 7 wherein the substrate is adapted to frame and surround the input area of the input device

9. An optical system according to claim 7 wherein the substrate is a plate, wherein a region of the plate surrounded by the unitary collimating lens element defines the input area of the input device.

10. An optical system according to claim 1 wherein the waveguides are integral with the collimating lens element.

11. An optical system according to claim 1 wherein the collimating lens element is integral with the substrate

12. An optical system according to claim 1 further comprising a cladding layer disposed between the waveguides and the substrates, wherein the cladding layer comprises a refractive index lower than the waveguides for minimizing leakage of an optical signal from the waveguides into the substrate, and wherein the cladding layer provides optical alignment of an optical axis of the waveguides with an optical axis of the collimating lens element.

13. A method for producing an optical system, comprising:
providing a plurality of waveguides on a substrate;
providing a unitary collimating lens element on the substrate and positioning the lens element adjacent the waveguides such that the lens element is optically coupled to the plurality of waveguides.

14. A method according to claim 13 wherein each the waveguide terminates in a planar lens adapted to collimate light in a plane defined by the substrate

15. A method according to claim 13 wherein the physical height of the collimating lens element is from about 10 to about 1000 times the physical height of the waveguides

16. A method according to claim 13 further comprising producing the plurality of waveguides and the unitary collimating lens element simultaneously with the substrate.

17. A method according to claim 13 further comprising producing the plurality of waveguides and the unitary collimating lens element separately and attaching the plurality of waveguides and the unitary collimating lens element to the substrate

18. A collimating lens element for an optical system, comprising:
a unitary non-linear elongate lens body adapted for attachment to a substrate and for optical coupling to a plurality of waveguides,
the lens body sized to transmit or receive a plurality of optical signals respectively to or from the waveguides.

19. A collimating lens element according to claim 18 wherein a plurality of optical signals are produced by the waveguides and directed to the lens element, and wherein the lens body is adapted to transform the plurality of optical signals into a corresponding plurality of collimated optical signals.

20. A collimating lens element according to claim 19 wherein the physical height of the collimating lens element is from about 10 to about 1000 times the physical height of the waveguides.
